(19) United States
(12) Patent Application Publication
(10) Pub. No.: US 2007/0024146 A1
(43) Pub. Date: Feb. 1, 2007

(54) Single-phase motor and stator winding method thereof

(75) Inventors: Shih Ming Huang, Taoyuan Hsien (TW); Kun Chou Lee, Taoyuan Hsien (TW); Lee Long Chen, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/489,597

(22) Filed: Jul. 20, 2006

(30) Foreign Application Priority Data
Jul. 29, 2005 (TW) 094125797

(51) Int. Cl. H02K 1/00; H02K 23/02; H02K 15/00

(52) U.S. Cl. 310/180; 310/184; 29/596; 29/606

(57) ABSTRACT

A winding method of a motor stator comprises the steps of serially winding a wire on a plurality of odd poles along a first direction; pulling out a common terminal from the wire to serve as a first power terminal; serially winding the wire on a plurality of even poles along a second direction; and knotting a start and an end of the wire to form a second power terminal. A single-phase motor comprises a stator and a rotor. The stator has a plurality of poles and a wire, and the rotor cooperates with the stator. The wire serially winds odd poles of the plurality of poles along a first direction and then serially winds even poles of the plurality of poles along a second direction.

### BACKGROUND OF THE INVENTION

1. Field of Invention

The present invention relates to a motor and a stator winding method thereof, and more particularly to a single-phase motor and a stator winding method thereof.

2. Related Art

A DC brushless motor is a motor having excellent properties because it contains the advantages of a conventional DC motor, such as the capability of accelerating rapidly, the direct proportional relationship between the rotating speed and the externally applied voltage, and the direct proportional relationship between the torque and the armature current, and the advantage of the brushless structure which is almost free from the mechanical and electrical noises.

The brushless motors may be classified into a single-phase motor, a two-phase motor, a three-phase motor and a five-phase motor according to the method of wire winding of the stator, wherein the single-phase or the three-phase DC brushless motor is used more frequently. Comparing with the three-phase brushless motor, the single-phase brushless motor has the features of easy assembly and high yield.

FIG. 1 is a cross-sectional view showing a stator of a conventional single-phase brushless motor formed by using a radial winding method. In the conventional winding technology, as shown in FIG. 1, a single wire is wound on each pole of the stator in the same number of turns. Before the wire W is wound on a stator 10, one end of the wire W is formed into a first terminal P₁. Then, the wire W is serially wound on the poles 11, 12, 13 and 14 of the stator 10, and the other end of the wire W is formed into a second terminal P₂. Thus, the stator 10 can drive the rotor having N and S magnets using a single-coil motor driving circuit to generate an alternating magnetic field by applying positive and negative currents through the single coil.

When the output power of the single-phase brushless motor is increased and the current is thus increased, twin wires are wound on the poles in order to reduce the current flowing through each of the twin wires. FIG. 2 is a schematic view showing a stator winding method for the conventional brushless single-phase motor. As shown in FIG. 2, the twin wires W′ are serially wound on a plurality of poles 1 to 8 according to the sequence of the poles. Because the winding directions of the twin wires of the adjacent poles are different, the winding directions of the twin wires include the alternating clockwise and counterclockwise directions.

However, the method for winding the poles by the twin wires makes the irregular winding and low the slot-occupation ratio. In particular, when the diameters of the twin wires are increased, the insulating layers on the surfaces of the twin wires tend to be scratched due to wear, such that the motor is easily short-circuited. Furthermore, the alternating winding directions of the adjacent poles tend to wear the twin wires more easily.

It is thus imperative to provide a single-phase motor and a stator winding method thereof to solve the problems, such as the misalignment of the irregular winding, the low slot-occupation ratio and the trend of wearing between turns of the wire, when the stator is wound.

### SUMMARY OF THE INVENTION

In view of the foregoing, the present invention provides a single-phase motor and a stator winding method thereof in order to solve the above-mentioned problems, such as the misalignment of the irregular winding, the low slot-occupation ratio and the trend of wearing between turns of the wire, when the stator is wound.

To achieve the above, a stator winding method according to the present invention includes the steps of winding a wire on a plurality of odd poles along a first direction; pulling out a common terminal from the wire to serve as a first power terminal; winding the wire on a plurality of even poles along a second direction; and knotting a start and an end of the wire to form a second power terminal.

To achieve the above, another stator winding method according to the present invention includes the steps of winding a first wire on a plurality of odd poles along a first direction; winding a second wire on a plurality of even poles along a second direction; and respectively connecting two ends of the first wire and the second wire to form a first power terminal and a second power terminal.

To achieve the above, a single-phase motor according to the present invention includes a stator and a rotor. The stator has a plurality of poles and a wire. The plurality of poles has a plurality of odd poles and a plurality of even poles that are spaced apart and arranged alternately. The wire is wound onto odd poles along a first direction and then wound onto even poles along a second direction. The rotor cooperates with the stator.

To achieve the above, another single-phase motor according to the present invention includes a stator and a rotor. The stator has a plurality of poles, a first wire and a second wire. The plurality of poles has a plurality of odd poles and a plurality of even poles that are spaced apart and arranged alternately. The first wire is serially wound on the odd poles along a first direction. The second wire is serially wound on the even poles along a second direction. Two ends of the first wire and the second wire are correspondingly connected. The rotor cooperates with the stator.

As mentioned above, a single-phase motor and a stator winding method thereof according to the present invention have that a wire first serially winds the odd poles of a stator and then serially winds the even poles of the stator. Comparing with the prior art, the wire winding operations are smooth because they are wound at the same direction. Thus, the possibility of wearing the wire may be reduced, such that the surface of the wire cannot be easily scratched, the wire may be arranged regularly, and the slot-occupation ratio may be increased accordingly. In addition, the present invention can enhance the magnetic flux using the single wire having a larger diameter without using twin wires. So, it is unnecessary to use the machine of winding twin wires, and the apparatus cost may be reduced.

### BRIEF DESCRIPTION OF THE DRAWINGS

The present invention will become more fully understood from the detailed description given herein below illustration only, and thus are not limitative of the present invention, and wherein:

FIG. 1 is a cross-sectional view showing a stator of a conventional brushless single-phase motor formed using a radial winding method;

FIG. 2 is a schematic view showing a stator winding method for the conventional brushless single-phase motor,

FIG. 3 is a flow chart showing a stator winding method according to a first preferred embodiment of the present invention;

FIG. 4 is a cross-sectional view showing the stator winding method and a single-phase motor according to the first preferred embodiment of the present invention, wherein the number of poles is 8;

FIG. 5 is another schematic view showing the stator winding method according to the first preferred embodiment of the present invention, wherein the number of poles is 8;

FIG. 6 is another schematic view showing the stator winding method according to the first preferred embodiment of the present invention, wherein the number of poles is 4;

FIG. 7 is another schematic view showing the stator winding method according to the first preferred embodiment of the present invention, wherein the number of poles is 6;

FIG. 8 is a flow chart showing a stator winding method according to a second preferred embodiment of the present invention; and

FIG. 9 is a cross-sectional view showing the stator winding method and a single-phase motor according to the second preferred embodiment of the present invention, wherein the number of poles is 8.

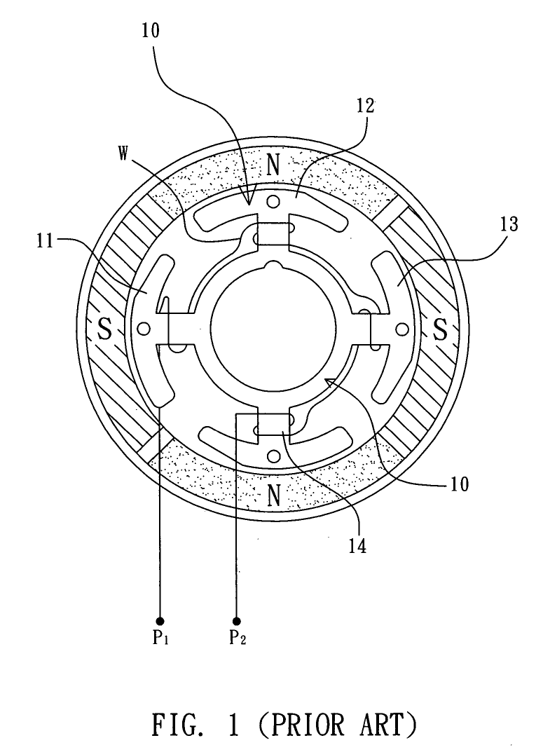

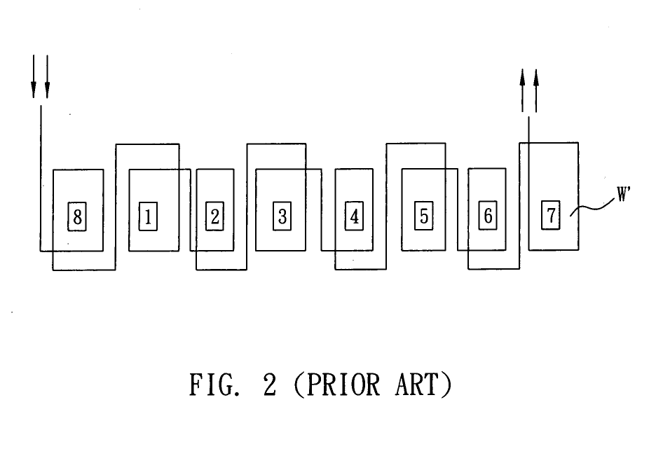

### DETAILED DESCRIPTION OF THE INVENTION

The present invention will be apparent from the following detailed description, which proceeds with reference to the accompanying drawings, wherein the same references relate to the same elements.

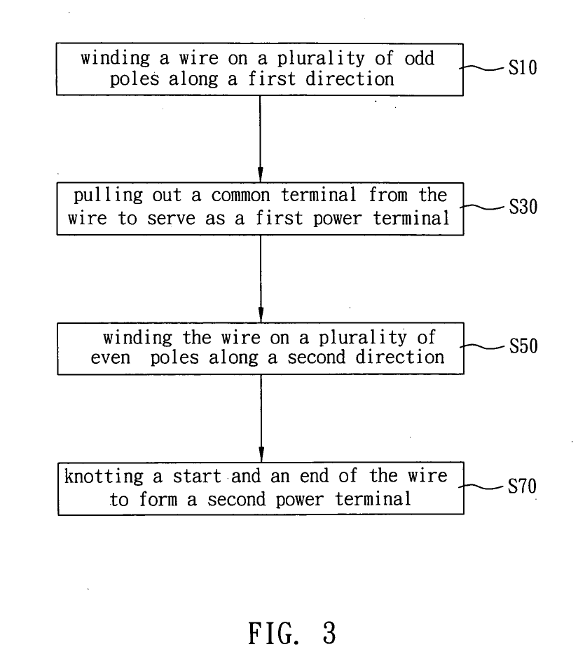

FIGS. 3 to 7 illustrate a stator winding method and a single-phase motor according to a first preferred embodiment of the present invention.

FIG. 3 is a flow chart showing a stator winding method according to a first preferred embodiment of the present invention. As shown in FIG. 3, the stator winding method includes the steps of: (step S10) winding a wire on a plurality of odd poles along a first direction; (step S30) pulling out a common terminal from the wire to serve as a first power terminal; (step S50) winding the wire on a plurality of even poles along a second direction; and (step S70) knotting a start and an end of the wire to form a second power terminal. In this embodiment, the stator is applied to a brushless single-phase motor.

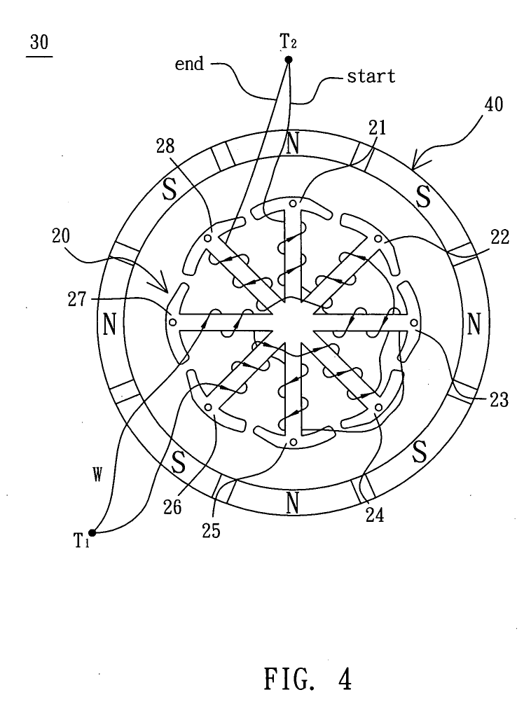

FIG. 4 is a cross-sectional view showing the stator winding method and a single-phase motor according to the first preferred embodiment of the present invention. As shown in FIGS. 3 and 4, the odd poles are wound with the wire W along the first direction in step S10. In this embodiment, the stator 20 has 8 poles, wherein the first direction for the wire W to wind the poles may be a counterclockwise direction or a clockwise direction. In this embodiment, the odd poles, including a first pole 21, a third pole 23, a fifth pole 25 and a seventh pole 27, are wound along the clockwise direction. The so-called clockwise direction represents the winding direction of the wire W when viewed from an outer edge of the pole toward the center of the stator. The number of wound turns of the wire on the poles may be determined according to the practical requirement. The numbers of turns on the odd pole and the even pole may be the same or different from each other.

Because the wire W is wound first on the first pole 21, the end of the wire on the first pole 21 is referred to as a start. The diameter of the wire W may be selected according to the practical requirement. As the diameter of the wire gets larger, the flowing current gets larger, and the output power of the motor gets larger. Of course, the wire W may have two parallel lines or multiple parallel lines, and the two wires may be directly wound at the same time.

In step S30, a common terminal is pulled out to serve as a first power terminal T₁ of the coil, through which the current is inputted or outputted.

In step S50, the wire W winds the even poles along the second direction, wherein the winding sequence may go from a second pole 22 to a fourth pole 24, a sixth pole 26 and an eighth pole 28, from the sixth pole 26 to the fourth pole 24, the second pole 22 and the eighth pole 28, or from the eighth pole 28 to the second pole 22, the fourth pole 24 and the sixth pole 26. In this embodiment, because the wire W ends at the eighth pole 28, the end of the wring on the eighth pole 28 is referred as an end. The second direction for the wire W to wind on the poles may be a counterclockwise direction or a clockwise direction. In addition, the first direction may be the same as or different from the second direction.

In step S70, the start and the end of the wire W are knotted to form a second power terminal T₂, through which the current is inputted or outputted.

After the stator winding steps are finished, the current may be inputted into the first power terminal T₁ to flow through all the poles. Of course, when the current direction is changed, it is also possible to input the current into the second power terminal T₂. If the current is inputted into the first power terminal T₁ (the arrow on the wire W indicates the current direction), N poles are formed on the first pole 21, the third pole 23, the fifth pole 25 and the seventh pole 27, and S poles are formed on the second pole 22, the fourth pole 24, the sixth pole 26 and the eighth pole 28. If the current is inputted into the second power terminal T₂, S poles are formed on the first pole 21, the third pole 23, the fifth pole 25 and the seventh pole 27, and N poles are formed on the second pole 22, the fourth pole 24, the sixth pole 26 and the eighth pole 28. That is, either the current is inputted into the first power terminal T₁ or the second power terminal T₂, the odd poles and the even poles have different polarities. Thus, alternating the direction of the current on the coil can drive the rotor, which is cooperated with the stator, to rotate.

Referring again to FIG. 4, a single-phase motor 30 according to a preferred embodiment of the present invention includes a stator 20 and a rotor 40 cooperated with the stator 20. The rotor 40 may have permanent magnets mounted around the stator 20. Alternating the direction of the current flowing into the power terminal T₁ or T₂ can change the polarity of each of the poles 21 to 28 of the stator 20 so as to rotate the rotor 40.

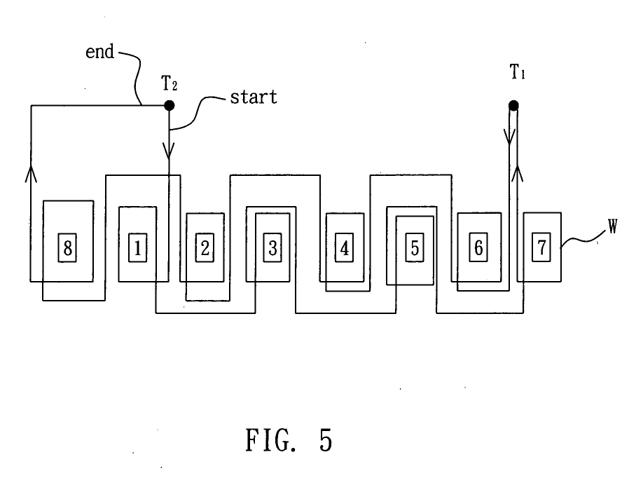

FIG. 5 is another schematic view showing the stator winding method according to the first preferred embodiment of the present invention, wherein the number of poles is 8. The wire W first winds odd poles 1, 3, 5 and 7 along the clockwise direction. Then, a common terminal is pulled out to serve as a first power terminal T₁. Then, the wire W winds even poles 6, 4, 2 and 8 along the clockwise direction, wherein the arrow on the wire W indicates the winding direction. Finally, the start and the end of the wire W are knotted to form a second power terminal T₂.

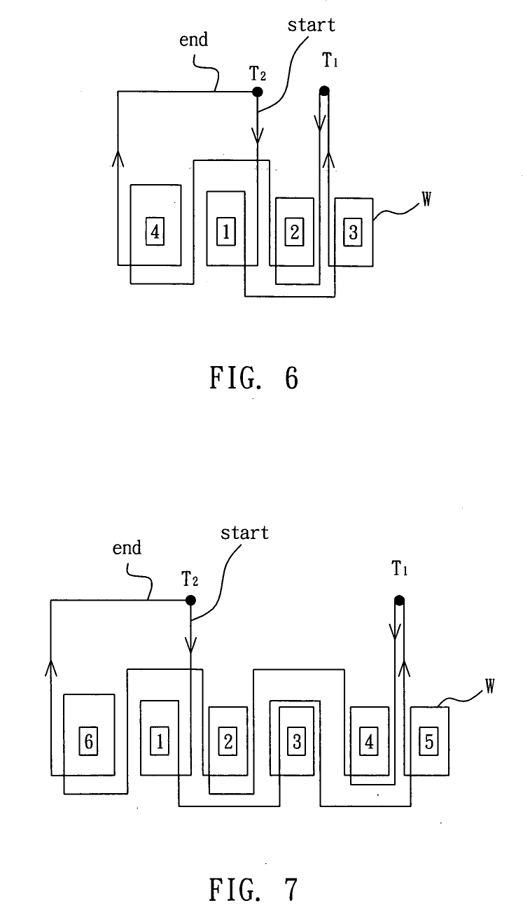

FIGS. 6 and 7 are another schematic views showing the stator winding method according to the first preferred embodiment of the present invention, wherein the number of poles respectively is 4 and 6. Although the numbers of poles are different, the wire still can be wound according to the stator winding method of the present invention.

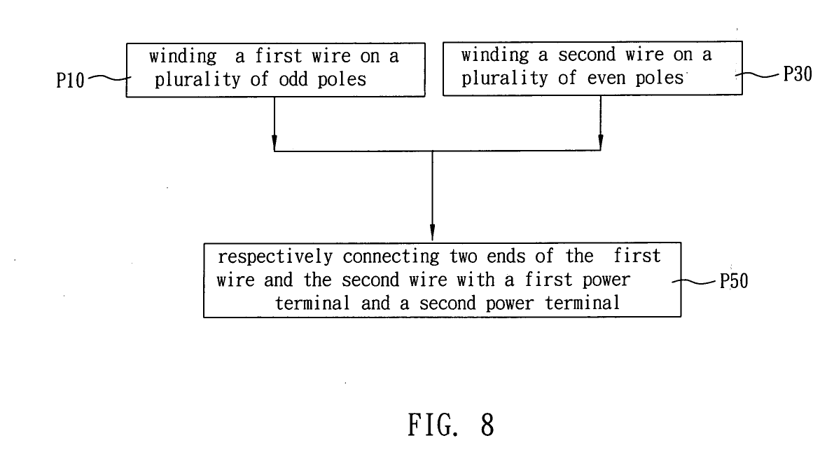

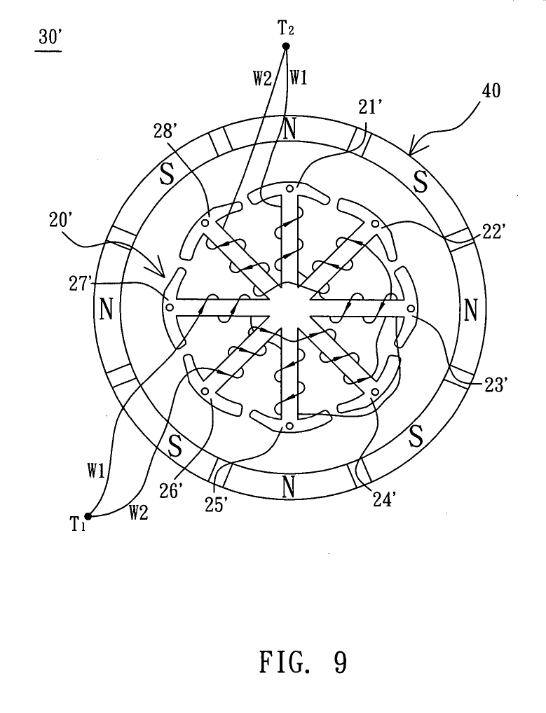

FIGS. 8 and 9 illustrate a stator winding method and a single-phase motor according to a second preferred embodiment of the present invention.

The stator winding method includes the steps of: (step P10) winding a first wire on a plurality of odd poles; (step P30) winding a second wire on a plurality of even poles; and (step P50) respectively connecting two ends of the first wire and the second wire with a first power terminal and a second power terminal. In this embodiment, the stator is applied to a brushless single-phase motor.

In step P10, a first wire W1 winds a plurality of odd poles. In this embodiment, the stator 20′ has 8 poles, wherein the winding direction of the first wire W1 may be a counterclockwise direction or a clockwise direction. In this embodiment, the winding direction of the first wire W1 for winding the odd poles is the clockwise direction, wherein the sequence may go from the first pole 21′ to the third pole 23′, the fifth pole 25′ and the seventh pole 27′, from the third pole 23′ to the fifth pole 25′, the seventh pole 27′ and the first pole 21′, or from the fifth pole 25′ to the seventh pole 27′, the first pole 21′ and the third pole 23′. The number of turns for the first wire W1 to wind the poles may be determined according to the practical requirement, and the number of turns of the odd poles and the even poles may be the same as or different from each other.

In step P30, a second wire W2 winds a plurality of even poles, wherein the winding sequence may go from the second pole 22′ to the fourth pole 24′, the sixth pole 26′ and the eighth pole 28′, from the sixth pole 26′ to the fourth pole 24′, the second pole 22′ and the eighth pole 28′, or from the eighth pole 28′ to the second pole 22′, the fourth pole 24′ and the sixth pole 26′. That is, two different wires W1 and W2 are used to respectively wind the odd poles and the even poles. In this embodiment, the second wire W2 winds the even poles (the second pole 22′, the fourth pole 24′, the sixth pole 26′ and the eighth pole 28′) along the counterclockwise direction. Steps P30 and P10 may be performed simultaneously. 0 In step P50, the two ends of the first wire W1 and the second wire W2 are respectively connected or knotted to form the first power terminal T₁ and the second power terminal T₂. That is, the two ends of the first wire W1 are respectively connected with the first power terminal T₁ and the second power terminal T₂, and the two ends of the second wire W2 are respectively connected with the first power terminal T₁ and the second power terminal T₂.

After the stator winding steps are finished, the current may be inputted into the first power terminal T₁ or T₂ to flow through all the poles. If the current is inputted into the first power terminal T₁ (the arrows on the wire indicates the current direction), N poles are formed on the first pole 21′, the third pole 23′, the fifth pole 25′ and the seventh pole 27′, and S poles are formed on the second pole 22′, the fourth pole 24′, the sixth pole 26′ and the eighth pole 28′. That is, the odd pole and the even pole have different polarities. Thus, alternating the direction of the current on the coil can rotate the rotor.

As shown in FIG. 9 again, a single-phase motor 30′ according to another preferred embodiment of the present invention includes a stator 20′ and a rotor 40 cooperated with the stator 20′. The rotor 40 may have permanent magnets mounted on the stator 20′. Alternating the direction of the current flowing into the power terminal T₁ or T₂ can rotate the rotor 40.

In summary, a single-phase motor and a stator winding method thereof according to the present invention have that a wire first serially winds the odd poles of a stator and then serially winds the even poles of the stator. Comparing with the prior art, the wire winding operations are smooth because they are wound at the same direction. Thus, the possibility of wearing the wire may be reduced, such that the surface of the wire cannot be easily scratched, the wire may be arranged regularly, and the slot-occupation ratio may be increased accordingly. In addition, the present invention can enhance the magnetic flux using the single wire having a larger diameter without using twin wires. So, it is unnecessary to use the machine of winding twin wires, and the apparatus cost may be reduced.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A stator winding method, comprising the steps of:
winding a wire on a plurality of odd poles of a stator along a first direction;
pulling out a common terminal from the wire to serve as a first power terminal;
winding the wire on a plurality of even poles of the stator along a second direction; and
knotting a start and an end of the wire to form a second power terminal.

2. The stator winding method according to claim 1, wherein the first direction and the second direction are respectively a counterclockwise direction or a clockwise direction.

3. The stator winding method according to claim 1, wherein the first direction is the same as or different from the second direction.

4. The stator winding method according to claim 1, wherein the odd poles and the even poles have different polarities.

5. The stator winding method according to claim 1, wherein the numbers of turns of the wire for winding the odd poles and the even poles are the same or different.

6. The stator winding method according to claim 1, wherein the wire has multiple parallel lines.

7. A stator winding method, comprising the steps of:
winding a first wire on a plurality of odd poles of a stator;
winding a second wire on a plurality of even poles of the stator, and
respectively connecting two ends of the first wire and the second wire with a first power terminal and a second power terminal.

8. The stator winding method according to claim 7, wherein the odd poles and the even poles have different polarities.

9. The stator winding method according to claim 7, wherein the numbers of turns of the wire for winding the odd poles and the even poles are the same or different.

10. The stator winding method according to claim 7, wherein the first wire or the second wire has multiple parallel lines.

11. A motor, comprising:
a stator having a plurality of poles, wherein a wire is wound onto odd poles of the plurality of poles along a first direction and then wound onto even poles of the plurality of poles along a second direction; and
a rotor cooperating with the stator.

12. The motor according to claim 11, wherein a first power terminal is pulled out from the wire between the odd poles and the even poles.

13. The motor according to claim 11, wherein two ends of the wire are knotted to form a second power terminal.

14. The motor according to claim 11, wherein the first direction and the second direction are respectively a counterclockwise direction or a clockwise direction.

15. The motor according to claim 11, wherein the first direction is the same as or different from the second direction.

16. The motor according to claim 11, wherein the odd poles and the even poles have different polarities.

17. The motor according to claim 11, wherein the numbers of turns of the wire for winding the odd poles and the even poles are the same or different.

18. The motor according to claim 11, wherein the wire has multiple parallel lines.

19. The motor according to claim 11, wherein the wire comprises a first wire and a second wire, wherein the first wire is wound on the odd poles of the plurality of poles along the first direction, the second wire is wound on the even poles of the plurality of poles along the second direction, and two ends of the first wire and the second wire are correspondingly connected.

20. The motor according to claim 11, being a brushless single-phase motor.
